(19) United States
(12) Patent Application Publication
(10) Pub. No.: US 2013/0336717 A1
(43) Pub. Date: Dec. 19, 2013

(54) Grommet and Flange holder and mounting system for small devices

(71) Applicant: James Shelby Gragg, Somerville, MA (US)

(72) Inventor: James Shelby Gragg, Somerville, MA (US)

(21) Appl. No.: 13/902,914

(22) Filed: May 27, 2013

Related U.S. Application Data
(60) Provisional application No. 61/654,059, filed on May 31, 2012.

(51) Int. Cl. F16B 17/00

(52) U.S. Cl. CPC F16B 17/00
USPC 403/345

(57) ABSTRACT

A mounting system characterized by a mounting point in the form of a grommet, and a frame in the form of a flange designed to securely engage the grommet, allowing a device, with an attached frame, to be placed in a fixed position, and removed, as desired by the user of the device. The user of this system may employ a range of mounting points in different locations, allowing a device to be fixed in a variety of locations as needed. This would also allow different device/frame combinations to be attached to a given mounting point. The mounting points and frames can be formed by a wide range of materials, the ability to securely engage/disengage being the limiting factor.

### BACKGROUND OF THE INVENTION

The present invention relates to handheld equipment holders and mounting systems and, more particularly, to a grommet and flange holder and mounting system for small devices such as tablet computers.

As handheld equipment becomes increasingly common, more devices are being used in a varied range of environments. As these are frequently designed for handheld use, it becomes difficult to keep these devices close at hand, despite the need to use our hands for more immediate tasks. Being designed for handheld use, there is often no satisfactory method of monitoring multiple devices without physically holding them.

Conventional devices are designed to position different small devices, however, these are generally designed for use with one specific piece of equipment and frequently, only designed for the most popular items. Additionally, these are often designed to be used in only one position or environment. These conventional devices are also designed with multiple moving parts (clips, springs, and the like) that can present points of failure.

As can be seen, there is a need for an improved handheld equipment holder and mounting system.

### BRIEF DESCRIPTION OF THE DRAWINGS

FIG. 1 is an exploded view of a grommet and flange holder and mounting system according to an exemplary embodiment of the present invention;

FIG. 2 is a cross-sectional view of the grommet and flange holder of FIG. 1, as mounted;

FIG. 3 is a cross-sectional view of the grommet and flange holder of a tamper resistant grommet, as mounted;

FIG. 4 is top view of a sectioned grommet according to an exemplary embodiment of the present invention;

FIG. 5 is a cross-sectional view taken along section A of FIG. 4;

FIG. 6 is a cross-sectional view taken along section B of FIG. 4; and

FIG. 7 is a perspective view of the sectioned grommet of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a grommet and flange holder and mounting system for small devices such as tablet computers and other portable devices. The device, when attached to small, or handheld equipment, is designed to mate to a mount that allows for attachment and release for secure positioning of handheld equipment, while maintaining the device's portability.

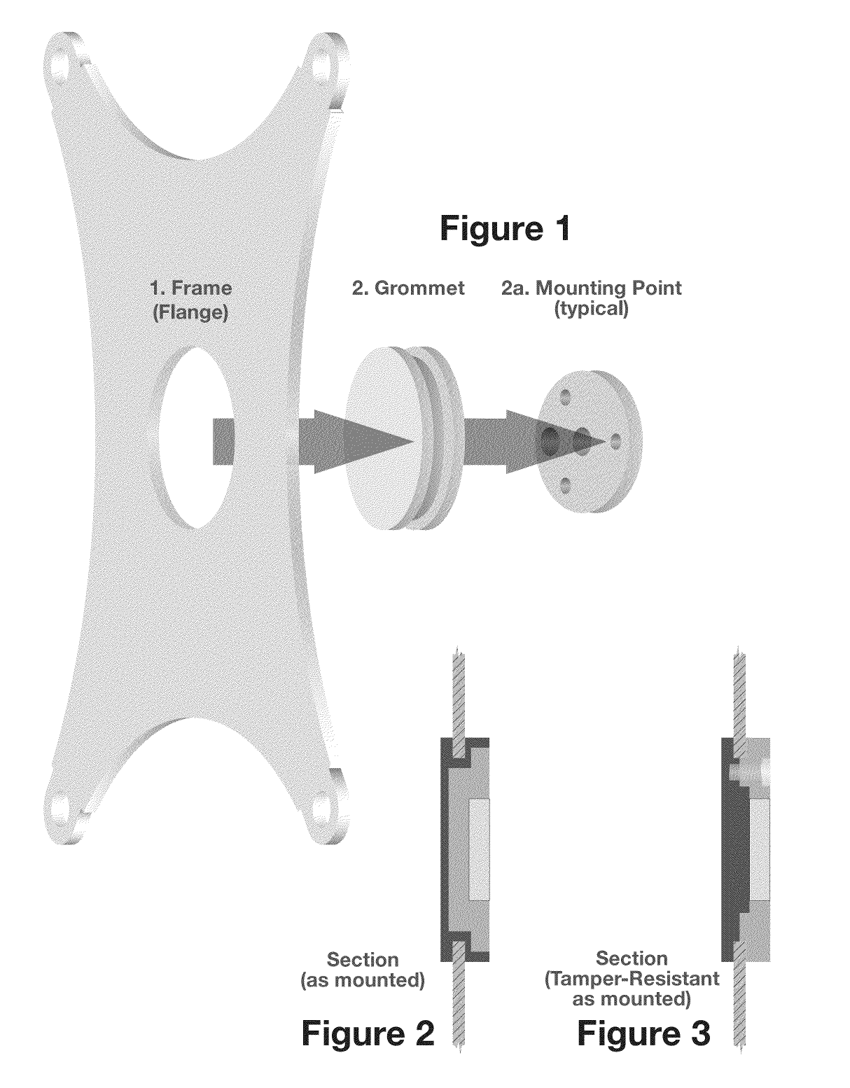

Referring now to FIGS. 1 and 2, a frame or flange (1) is adapted to fit snugly in the mount (2). The exposed surface of the mount (2) can be formed of a resilient, but flexible material that will yield to the frame (1) as it is seated into the grommet. The mount (2) can be fixed by means of one of a range of components/mounting points (2a) that fix the grommet in place. Once the frame is seated, the mount also behaves as an axle, allowing for rotation of the frame around the mount. Each frame (1) may be used with a variety of mounts (2), as it is used in different locations and environments.

The mount (2) is fixed in position. This can be accomplished by a variety of means using different mounting points (2a), such as a permanent mount attached to a wall or furniture with screws or bolts, a magnetic attachment adhered to a file cabinet or steel beam, a clamp such as would fit on bicycle handlebars, a threaded socket that would attach to a tripod, an attachment with an adjustable strap that can fit tightly around a large or irregularly shaped object, a spike that can be hammered into a utility pole or rock crevice, or the like. The above list describes exemplary mounting points (2a) and others are contemplated within the scope of the present invention. Once the mounting point (2a) and grommet (2) are in place, a device with a frame fitted to it can be mated to the mount. In some embodiments of the present invention, tamper resistant fittings, as in FIG. 3, may be employed to prohibit removal of the device by unauthorized users. For example, unattended uses such as securing a tablet computer as an interactive display for museum or gallery.

The frame (1) is designed to be portable and is not required to be used with only a single mount. A user may have several mounts placed in locations where the device has an anticipated use. Likewise, for economy, a mount (2) can be used interchangeably with different mounting points (2a).

The frame (1) can be created in a wide range of materials, such as metal, wood, plastic, glass, carbon fiber, and the like, and can be designed in a wide range of styles from strictly utilitarian to highly ornamental, as desired. The only manufacturing requirement in the frame (1) is that the hole used for mating the frame to the mount needs to be manufactured to the proper tolerances to seat the frame properly.

The mount (2) is more restrictive in use of materials due to the requirements of the seating method employed. As envisioned, the mount can be made of two parts. The first part is a strong core, typically made of metal, which serves as the attachment point for the various mounting points (2a). This part requires machining for the chosen fasteners (drilling, tapping, or the like). The second part is the outer surface which forms the grommet. As this needs to be a single piece, form-fitted to both the core and the dimensions needed to create a snug fitting grommet, ideally this would be molded over a strong core. The grommet may be made from various materials, such as silicone, rubber, plastic, or the like, that can be formed in the desired contours during manufacturing.

To use the mounting system of the present invention, a user would fix a device, which has a frame mated to it, to the mount by bringing the hole in the frame down into the groove in the mount. At this point, the frame will be seated roughly halfway into the mount. The frame can then be rotated with pressure applied in the direction of the mount, allowing the remaining outer portion of the flexible material of the mount to pull through and seat the frame in place on the mount.

To use a tamper resistant variant of the mounting system, it is envisoioned that the grommet can be formed of a strong material in multiple parts, being joined together to seat the frame securely, and thus forming the grommet.

The present invention provides a mounting system that is designed with a minimum of moving parts and for ease of use. The mounting system is adaptable for use with multiple devices and adaptable to position on/against different surfaces and in different environments. The mounting system also allows for 360 degrees of rotation of the attached device while mounted for improved positioning.

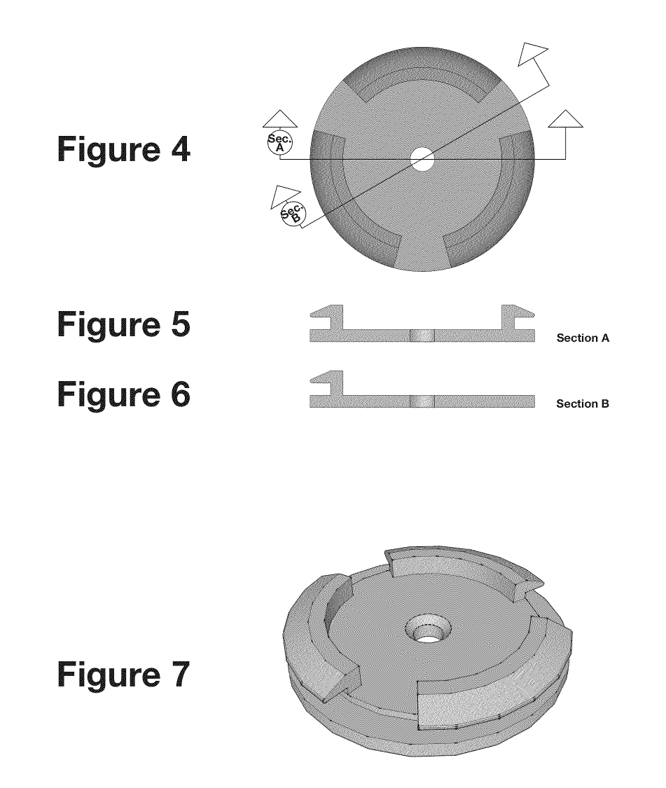

It is also envisioned that variants of the grommet can be of single piece construction, where the mounting point and grommet are integrated in one piece. In some embodiments, as shown in FIG. 4, the grommet may be formed in segments. The segments are spaced to allow the grommet segments to flex when pressure is applied to the flange, perpendicular to the grommet, causing the flange to seat therein. In this segmented embodiment, the grommet is formed of a material sufficiently flexible to yield when pressure is applied.

It should be understood, of course, that the foregoing relates to exemplary embodiments of the invention and that modifications may be made without departing from the spirit and scope of the invention as set forth in the following claims.

What is claimed is:

1. A mounting system comprising:
a frame adapted to be attached to a piece of equipment to be mounted, the frame having a hole formed therethrough;
one or more mounting points adapted to be fixed in position at one or more desired mounting locations; and
one or more grommets, each attached to a mounting point, the recess in the grommet adapted to engage the frame to secure the equipment in the mounting system.
